(19) United States
(12) Patent Application Publication
(10) Pub. No.: US 2011/0026076 A1
(43) Pub. Date: Feb. 3, 2011

(54) PRINTER DRIVER, PRINTER AND PRINTING METHOD

(76) Inventor: Takashi SAWANO, Osaka (JP)

Correspondence Address: BIRCH STEWART KOLASCH & BIRCH, PO BOX 747, FALLS CHURCH, VA, 22040-0747, US

(21) Appl. No.: 12/834,593

(22) Filed: Jul. 12, 2010

(30) Foreign Application Priority Data
Jul. 31, 2009 (JP) 2009-178802

(51) Int. Cl. G06F 3/12

(52) U.S. Cl. 358/1.15

(57) ABSTRACT

It makes possible that printing is performed without causing a user to be mixed up in outputting a plurality of sets of printed matter concerning the same image information, even when the printing is performed on the same type of sheets between the sets. A printer or a computer connected to the printer performs a setting to print a plurality of sets concerning the image information to be printed and performs a setting to print with addition of different visible additional image information for each set based on a user operation, and generates printing data from the image information to be printed based on the set setting information. The printer executes printing of the printing data.

### CROSS-NOTING PARAGRAPH

This non-provisional application claims priority under 35 U.S.C. §119(a) on Patent Application No. 2009-178802 filed in JAPAN on Jul. 31, 2009, the entire contents of which are hereby incorporated herein by reference.

### FIELD OF THE INVENTION

The present invention relates to a printer driver, a printer and a printing method, and more specifically, to a printer driver capable of performing a setting to print a plurality of sets of image information to be printed, a printer capable of printing a plurality of sets of image information to be printed, and a printing method using the printer.

### BACKGROUND OF THE INVENTION

Conventionally, some printers of multi-functional peripherals, single-function printers with only a printing function, or the like, have a function to control such that same page data is printed respectively on each paper supplied from different paper trays. This function is also called a carbon printing function. With this function, for example, printing is performed on white paper and colored paper such as yellow paper, blue paper or the like, as the original and as a duplicate respectively, and thus making it possible to reduce mixing up of the original and the duplicate on which the same recording contents are printed.

On the other hand, Japanese Laid-Open Patent Publication No. 11-143657 discloses a printing processing apparatus capable of designating a printing paper size and synthesis with various stamp images as a setting at the time of printing.

However, in printing the same printing data to make the original and a duplicate, since the conventional carbon printing function performs distinction with only the difference in types of sheets, in the case of printing on the same type of sheets as the original and the duplicate, mixing up thereof will occur. Note that, this issue is not able to be solved with the technology described in Japanese Laid-Open Patent Publication No. 11-143657.

### SUMMARY OF THE INVENTION

An object of the present invention is to provide a printer driver, a printer and a printing method capable of printing without causing a user to be mixed up, in outputting a plurality of sets of printed matter such as a set for the original or a set for a duplicate, a set for saving or a set for sending, etc., concerning the same image information, even when printing is performed on the same type of sheets between the sets.

The first technical means of the present invention is a printer driver which is incorporated in a computer to perform a printing instruction to a printer connected to the computer, wherein the printer driver includes a program to cause the computer to execute: a plurality of sets setting step of performing a setting to print a plurality of sets concerning image information to be printed based on a user operation; an additional setting step of performing a setting to print with addition of different visible additional image information for each set based on a user operation; and a printing data generating step of generating printing data from the image information based on setting information set at the plurality of sets setting step and the additional setting step.

The second technical means of the present invention is the printer driver as defined in the first technical means, wherein a program to cause the computer to execute a tray setting step of performing a setting of a tray to supply paper in printing for each set based on a user operation is further included, and the printing data generating step generates printing data from the image information based on the setting information set at the plurality of sets setting step, the additional setting step, and the tray setting step.

The third technical means of the present invention is the printer driver as defined in the first technical means, wherein the additional setting step has a step of setting whether or not the additional image information is added for each set based on a user operation.

The forth technical means of the present invention is the printer driver as defined in the first technical means, wherein the additional setting step has a step of setting a pattern to be printed as the additional image information for each set based on a user operation.

The fifth technical means of the present invention is the printer driver as defined in the first technical means, wherein the additional setting step has a step of setting a character string to be printed as a part of the additional image information for each set based on a user operation.

The sixth technical means of the present invention is the printer driver as defined in the first technical means, wherein the additional setting step has a step of performing a setting that the additional image information is printed either in color or in monochrome for each set based on a user operation.

The seventh technical means of the present invention is the printer driver as defined in the first technical means, wherein the additional image information includes information to specify the printer, the printer driver, or the computer.

The eighth technical means of the present invention is the printer driver as defined in the first technical means, wherein the computer is connected to a server which stores the additional image information, and the printing data generating step has a step of obtaining the additional image information from the server in case where a setting to add the additional image information which has been stored in the server is performed at the additional setting step.

The ninth technical means of the present invention is the printer driver as defined in the first technical means, wherein a program to cause the computer to execute an image data generating step for generating and saving image data with the additional image information added thereto from the image information based on the setting information set at the plurality of sets setting step and the additional setting step is further included.

The tenth technical means of the present invention is a printer which prints an image show by an image information inputted thereto on recording material, comprising: a plurality of sets setting portion to perform a setting to print a plurality of sets based on a user operation concerning the inputted image information; an additional setting portion to perform a setting to print with addition of different visible additional image information for each set based on a user operation; a printing data generating portion to generate printing data from the image information based on setting information set at the plurality of sets setting portion and the additional setting portion; and a printing portion to print the printing data generated in the printing data generating portion.

The eleventh technical means of the present invention is a printing method of performing printing using a printer, including: a plurality of sets setting step of performing a setting to print a plurality of sets concerning image information to be printed by the printer or a computer connected to the printer based on a user operation; an additional setting step of performing a setting to print with addition of different visible additional image information for each set by the printer or the computer based on a user operation; a printing data generating step of generating printing data from the image information by the printer or the computer based on setting information set at the plurality of sets setting step and the additional setting step; and a step of executing printing of the printing data by the printer.

### BRIEF DESCRIPTION OF THE DRAWINGS

FIG. 1 is a diagram showing an exemplary configuration of a printing system including a computer in which a printer driver according to the present invention is installed, and a printer;

FIG. 2 is a diagram showing an exemplary configuration of the computer in the printing system of FIG. 1;

FIG. 3 is a functional block diagram showing an example of the printer driver in the computer of FIG. 2;

FIG. 4 is a diagram showing an example of a UI image for a printing setting displayed by the printer driver according to the present invention;

FIG. 5 is a flowchart for explaining an example of processing of the printer driver after performing a setting in the UI image of FIG. 4;

FIG. 6 is a flowchart for explaining an example of processing in which printing data transmitted in the processing of FIG. 5 is printed by the printer;

FIG. 7 is a diagram showing an example of sets of printed matter in a case of executing printing according to the setting contents in the UI image shown in FIG. 4;

FIG. 8 is a diagram showing another exemplary configuration of the printing system including the computer in which the printer driver according to the present invention is installed, and the printer; and

FIG. 9 is a diagram showing another example of the UI image for a printing setting displayed by the printer driver according to the present invention.

### PREFERRED EMBODIMENTS OF THE INVENTION

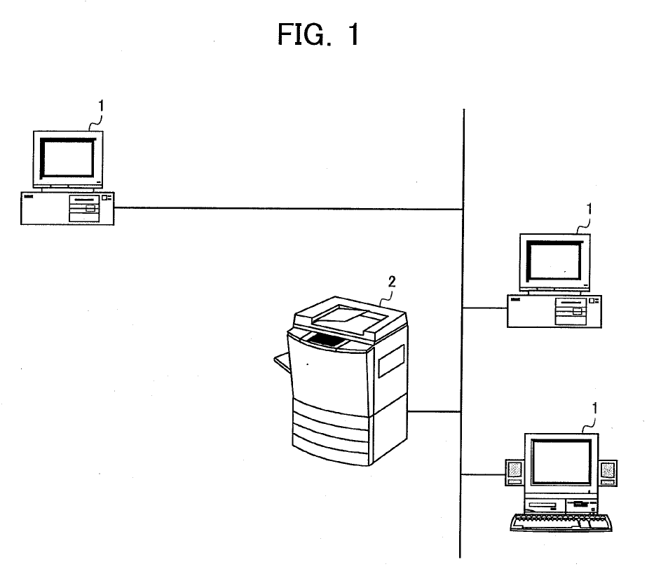

FIG. 1 is a diagram showing an exemplary configuration of a printing system including a computer in which a printer driver according to the present invention is installed, and a printer. The printing system illustrated in FIG. 1 has three computer 1s and a printer 2 which are connected to a LAN (Local Area Network). As the computer 1, a mainframe personal computer, a server computer and the like are included. In addition, the number of the computer 1 or the connecting method with the printer 2 is not limited thereto. The printer 2 is an image forming apparatus which forms an image on recording paper, and as the printer 2, for example, a multi-functional peripheral, a single-function printer having only a printing function, or the like is included.

In the computer 1, a printer driver, which will be described below, is installed. The computer 1 generates printing data including a printing command from image information to be printed by the printer driver based on a printing instruction operation by a user. Then, the computer 1 transmits the generated printing data to the printer 2 via the LAN.

When receiving the printing data, the printer 2 performs interpretation of the printing command included in the printing data and executes printing processing of the printing data.

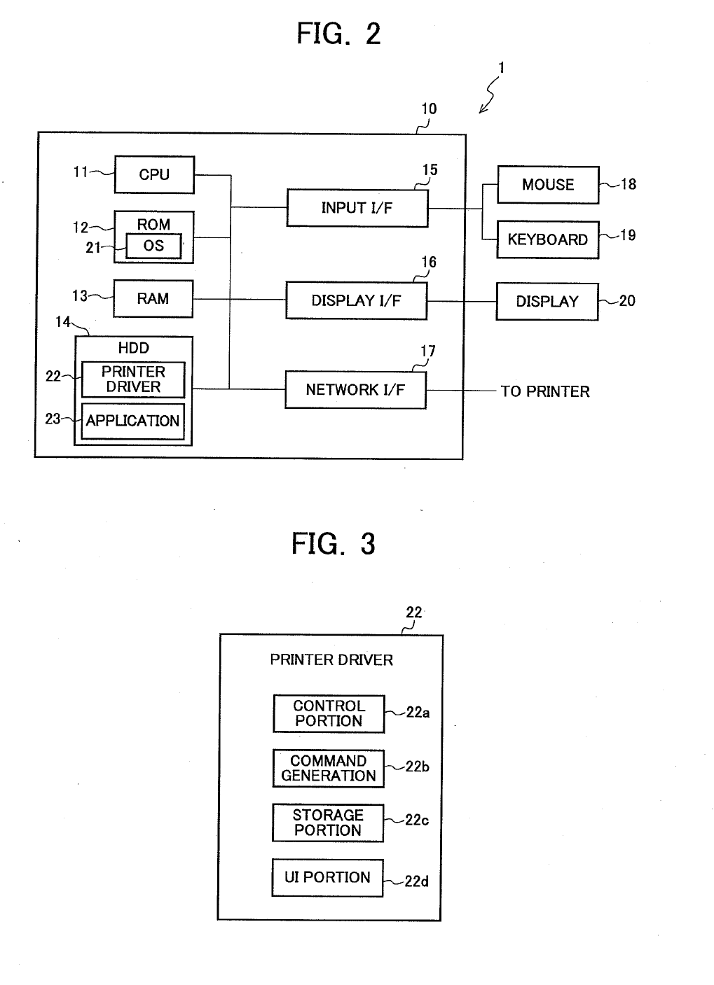

FIG. 2 is a diagram showing an exemplary configuration of the computer in the printing system of FIG. 1, and FIG. 3 is a functional block diagram showing an example of the printer driver in the computer of FIG. 2.

The computer 1 is provided with a computer main body 10, an operation input device including a pointing device such as a mouse 18, a keyboard 19 or the like, and a display (display device) 20. The computer main body 10 is provided with a CPU (Central Processing Unit) 11 which integrally controls the entire computer 1, a ROM (Read Only Memory) 12 which stores various programs, data and the like, a RAM (Random Access Memory) 13 which is used as a work area for temporarily storing various data, and an HDD (Hard Disk Drive) 14 which stores various programs, data or the like. The computer main body 10 is further provided with an input I/F 15 connected to the operation input device such as the mouse 18, the keyboard 19 or the like, a display I/F 16 connected to the display 20 and a network I/F 17 connected to the printer 2 through the LAN.

In the ROM 12, an OS (Operating System) 21 is recorded so as to be capable of reading out from the CPU 11. Note that, a part of the OS 21 may be recorded in the HDD. In the HDD 14, a printer driver 22 according to the present invention and application software (hereinafter, referred to simply as “application”) 23 such as text editing application software are recorded so as to be capable of reading out from the CPU 11.

The printing processing is performed by, for example, opening a file to be printed by executing the application 23 based on the OS 21, executing the printer driver 22 on the OS 21 based on a printing instruction by a user, performing a printing setting based on a user operation, and giving the printing execution instruction to the printer 2. Here, the operation of the user is performed by operation of the mouse 18, the keyboard 19 or the like, which is matched to the contents displayed on the display 20.

The printer driver 22 is a program which is incorporated in the computer 1 to give a printing instruction to the printer 2 connected to the computer 1, and provided with, as illustrated in FIG. 3, a command generating portion 22b, a storage control portion 22c, and a UI (User Interface) portion 22d along with a control portion 22a which controls the entire function of the printer driver 22.

The UI portion 22d receives operation from the operation input device such as the mouse 18 or the keyboard 19 and gives it to the control portion 22a. Furthermore, based on an instruction from the control portion 22a, the UI portion 22d performs a control of reading out a UI image corresponding to the operation from the HDD 14 or the like and causing the display 20 to display the UI image. The storage control portion 22c performs reading out control of various information required for the UI image or display thereof to the HDD 14 or the like, according to the instruction from the control portion 22a. The UI image includes an image of a screen for a printing setting to be performed, and the UI portion 22d gives the operation relating to the printing setting input from the operation input device to the control portion 22a during the UI image is being displayed. Note that, the operation from the operation input device is received through the input I/F 15 and the display control to the display 20 is performed through the display I/F 16.

According to the contents of the printing setting received at the UI portion 22d, the control portion 22a causes the storage control portion 22c to perform the storage control and controls the command generating portion 22b to generate the printing command. According to the instruction from the control portion 22a, the storage control portion 22c performs reading out control of a file (image information) to be printed, storage control and reading out control of various information including information of a printing setting required for printing to the HDD 14 or the like. The command generating portion 22b generates the printing command which the printer 2 is able to interprete according to the instruction from the control portion 22a and the contents of the printing setting. The control portion 22a develops thus read out file to the image information (image data) to generate the printing data, generates printing data including the printing command by adding a printing command to the printing data and transmits the generated printing data to the printer 2 through the network I/F 17. Note that, the generating procedure of the printing data is not limited thereto, and it is able to be generated directly from the generated printing command and the read out file.

As a main characteristic of the present invention, the printer driver 22 includes a program to cause the computer 1 to execute a plurality of sets setting step, an additional setting step, and a printing data generating step, as described below.

A plurality of sets setting step is a step of performing a setting of printing a plurality of sets concerning the image information to be printed based on a user operation. Here, one set means that the number of copies of printed matter in which image information to be printed is printed is one. When the image information to be printed is the information which is printed into three pages, for example, the one set is output as the printed matter of three pages. The plurality of sets mean, for example, a plurality of printed matters, such as a set for original and a set for a duplicate, or a set for saving and a set for sending, which include the same image information to be printed but are used for different purposes. For example, in the case of performing a setting of printing three sets, a first set of printed matter can be used as the original, a second set of printed matter as a first duplicate, a third set of printed matter as a second duplicate, respectively. In the present invention, it is assumed that a plurality of sets setting is especially used for printing the image information of a document which is able to be put into one page such as a bill or a slip. In such a case, one set is output as a printed matter of one page, and in the case of setting to print N sets, the printed matter of N sheets is output.

An additional setting step is a step of performing a setting to print each set by adding different additional image information thereto based on a user operation. As the additional image information, information or the like for printing additional image called a woven pattern, a watermark, or a stamp is included. Furthermore, the additional image information to be added is the information that is visible when it is printed on recording paper, however, it may be allowed to include a part that is invisible when it is printed on recording paper.

Furthermore, the additional image information may include information specifying the printer 2, the computer 1, or the printer driver 22 for executing printing (hereinafter, referred to as specifying information). As the specifying information, device information of the printer 2, device information of the computer 1, driver information or a serial number of the printer driver 22 are included. Thereby, an output source of the printed matter is able to be specified. Accordingly, even if the printed matter is taken out illegally, it is possible to point out the place from where it is taken out illegally. In addition, the specifying information may be printed to be visible, or may be printed to be invisible. In the case of latter, the printer 2 (in this case, however, assuming that a copy function or a scanning function are provided therein), other copiers, or the scanner devices may be set to have a function to recognize the specifying information at the time of copying or scanning the printed matter.

As an example of additional image information which is different for each set, in the example of the case where a setting to print three sets is performed as described above, for example, the first set of printed matter (original) with the first additional image information printed thereto, the second set of printed matter (first duplicate) with the second additional image information printed thereto, and the third set of printed matter (second duplicate) with the third additional image information printed thereto are able to be output by the setting at this additional setting step.

A printing data generating step is a step of generating printing data from the image information to be printed based on the setting information set at the plurality of sets setting step and the additional setting step. Since the printing data generated here is generated based also on the setting information set at the additional setting step, it is naturally the printing data that is the image information to be printed with the additional image information added thereto. The additional image information may be stored in the HDD 14 as a part of the printer driver 22, however, may be stored on the printer 2 side and the additional image information may merely be given to the printer 2.

With thus generated printing data, the printer 2 is capable of performing printing in the state where additional image information which is different for each set is combined with the image information to be printed. For example, it is possible to perform printing in the state where classification into the “original” and the “duplicate” is performed clearly, which is an original object of the carbon printing. Furthermore, it is possible to change different additional image information for each set even though the paper is supplied from the same paper supply tray and even in the case of printing on the same type of sheets. In this manner, according to the present invention, when outputting the plurality of sets of printed matter concerning the same image information, even in the case where printing is performed on the same type of sheets between the sets, it is possible to perform printing without causing a user to mix up them. In general, since the additional image information of the contents set by or the contents whose setting is confirmed by the user himself/herself is added, it is further possible to prevent the user from being confused.

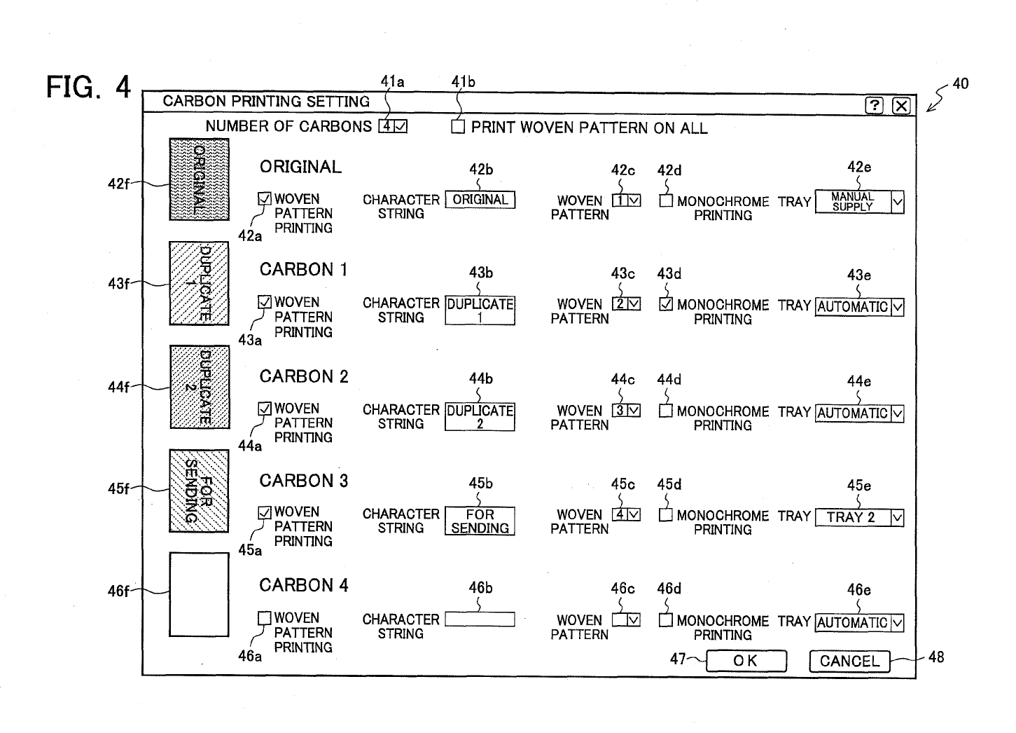

Description will hereinafter be given for specific processing by the printer driver 22 and the printer 2 in the example of woven pattern information as additional image information with reference to FIGS. 4 to 7. Note that, although it is assumed that the woven pattern is printed so as to be hidden under an image shown by image information to be printed as a result of printing, the woven pattern may be printed so as to be superimposed on the image shown by the image information to be printed as the result of printing.

FIG. 4 is a diagram showing an example of a UI image for a printing setting displayed on the display by the printer driver according to the present invention. In a UI image 40 illustrated in FIG. 4, a pull-down menu 41a for setting the number of carbons is displayed. As an example, description will be given for a UI image in a case where a setting is performed for printing four carbons, that is, a setting is performed for printing five sets.

In the UI image 40 of this example, setting items for an original (first set), setting items for a carbon 1 (second set), setting items for a carbon 2 (third set), setting items for a carbon 3 (fourth set), and setting items for a carbon 4 (fifth set) are displayed.

In addition, as setting items for each set, check boxes 42a, 43a, 44a, 45a, and 46a of whether or not the woven pattern printing is executed, entry fields of a character string 42b, 43b, 44b, 45b, and 46b included (embedded) as a part of the woven pattern when the woven pattern printing is performed, pull-down menus 42c, 43c, 44c, 45c, and 46c for selecting and setting the woven pattern when the woven pattern printing is performed, check boxes 42d, 43d, 44d, 45d, and 46d for checking when the woven pattern printing is executed in monochrome, and pull-down menus 42e, 43e, 44e, 45e, and 46e for selecting and setting a paper supply tray are displayed.

Furthermore, in the UI image 40, a check box 41b of a setting to print all the sets with the woven pattern is also displayed, which is checked and thereby check boxes 42a, 43a, 44a, 45a, and 46a are automatically checked, making it possible to reduce labor of a user operation.

Furthermore, in the UI image 40, thumbnail images 42f, 43f, 44f, 45f, and 46f for visually displaying, for each set, a printing example in the case of performing a printing according to the contents set by setting items of each set are displayed. A user is thereby able to confirm an output state of each set. The thumbnail images 42f, 43f, and the like may be displayed as thumbnail images that are printed together with woven patterns that actual image information to be printed is set. The user is thereby able to confirm a more accurate output state.

As illustrated in the check boxes 42a, 43a, and the like of whether or not the woven pattern printing is executed, an additional setting step preferably has a step of setting whether or not the woven pattern information is added for each set. This makes it possible to perform or not to perform the woven pattern printing for each set.

In addition, as illustrated in the entry fields of a character string 42b, 43 and the like, the additional setting step preferably has a step of setting a character string to be printed as a part of the woven pattern information for each set based on the user operation. The user is thereby able to input an arbitrary character string (in a case where the entry field 42b and the like are used), or select and input among predetermined character strings (in a case where the pull-down menu is used). In particular, by making it possible to input the arbitrary character string, it becomes possible to provide versatility not to limit a purpose of use to such as an “original” and a “duplicate” but to make “for saving” and “for sending” and the like. In addition, a font, a size, and a color may be selectable. Causing the user to select colors enables to prevent that the woven pattern becomes less visible depending on the color of the woven pattern in a case where a sheet is colored paper, or the like.

In addition, as illustrated in the pull-down menus 42c, 43c, and the like, the additional setting step preferably has a step of setting a pattern to be printed as the woven pattern information for each set (at a position where imposing on the image information) based on the user operation. With the setting of the pattern, it is possible to select a pattern such as a design drawn by combining line segments as a so-called background pattern. For example, it may be configured such that it is possible to be selected by the user among a closely-spaced design, a largely-spaced design, and an intermediate design therebetween, or a length or a type of a line segment to be used in the design is able to be selected by the user. In addition, a color of the pattern may be selectable. Causing the user to select colors enables to prevent that the woven pattern becomes less visible depending on the color of the woven pattern in a case where a sheet is colored paper, or the like. As illustrated, different types of patterns are able to be selected for each set, and same types of patterns are able to be selected for two or more sets.

Furthermore, a user setting of a pattern is made possible so that in the case of illegal leakage of the printed matter and in specifying a leakage source, it is possible to distinguish not with a character string but with a pattern. Accordingly, even when specifying information is not included, only a printing person is able to judge the place from where the printed matter is illegally taken out.

When the check boxes 42d, 43d and the like are not checked, the woven pattern is printed in color. As illustrated in the check boxes 42d, 43d and the like, the additional setting step preferably has a step for performing a setting that the woven pattern information is printed either in color or in monochrome for each set based on the user operation. A setting, thereby, can be performed such that an original is in color printing and the others are in monochrome printing so that printing cost is able to be reduced. Furthermore, here, it may be configured such that a setting is able to be performed as a common setting to color/monochrome of image information to be printed itself as well as the woven pattern.

In addition, as illustrated in the pull-down menus 42e, 43e and the like, the printer driver 22 may further include a program to cause the computer 1 to execute a tray setting step for performing a setting of a tray to supply paper in printing for each set based on the user operation. In this case, at a printing data generating step, the printing data is generated from image information based on setting information set at the plurality of sets setting step, the additional setting step, and the tray setting step. This also makes it possible to control printing so as to generate a different woven pattern for each tray for supplying paper. Note that, it is not necessary to use different recording paper or set a different paper supply tray for each set. In addition, as to the pull-down menus 42e, 43e and the like, when printing is performed under a rule that a different type of paper is used in each set, a paper supply tray selected in one thereof, may be not selectable by the other sets.

When such selection items for each set are finished to be set, as a button for reflecting the setting to printing, an OK button 47 is displayed to be selectable by the user in the UI image 40. When the OK button 47 is selected by the user, it is possible to finish display of the UI image 40 and generate printing data to which the set contents are reflected. In addition, as a button to discard the set contents, a cancel button 48 is displayed to be selectable by the user in the UI image 40. When the cancel button 48 is selected by the user, it is possible to finish display of the UI image 40 and discard the set contents to return to a default value.

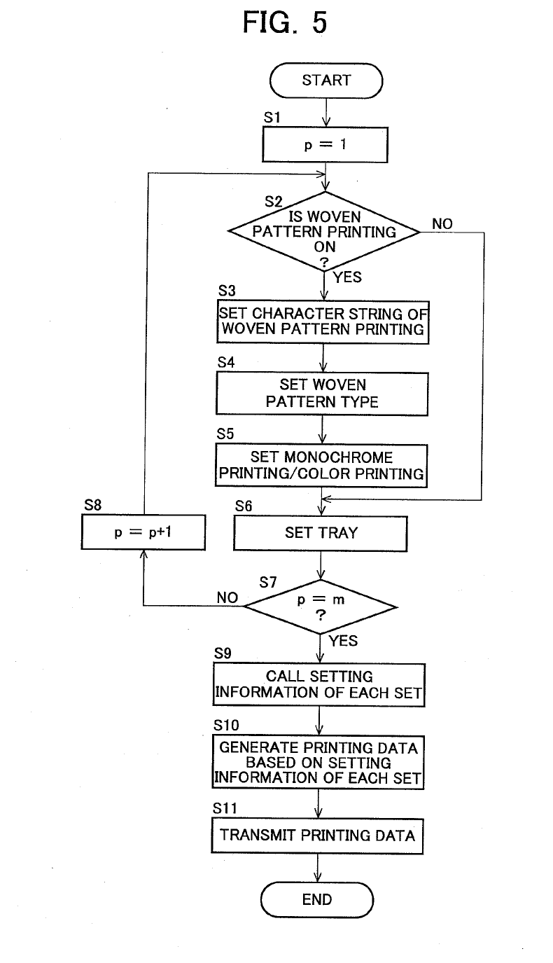

Description will be given for generation/transmission of printing data after the OK button 47 is selected with reference to FIG. 5. FIG. 5 is a flowchart for explaining an example of processing of the printer driver after performing a setting in the UI image of FIG. 4.

After displaying the UI image 40, when the user performs a printing setting and presses the OK button 47, first, the set contents (setting information) is saved (step S1 to S8). The setting information may be saved as a table describing each setting item for each set, for example.

At step S1, a set number p is set to 1. At step S2, it is judged whether or not the check boxes 42a and the like of the woven pattern printing are checked (ON) concerning a p-th set. In the case of no, the flow proceeds to S6, contents selected by the pull-down menus 42e and the like of the tray concerning the p-th set are saved in the setting table, the flow proceeds to S7, and whether or not p=m (m is the number of sets) is judged. In a case where p≠m, the flow proceeds to step S8, p is incremented, and the flow returns to step S2. At the time when p=m, the flow proceeds to step S9.

On the other hand, in the case of YES at step S2, concerning the p-th set, each of the character string to be embedded in the woven pattern (entry field 42b and the like), the woven pattern (pull-down menu 42c and the like), the setting of monochrome/color (check box 42d and the like) is saved in the setting table (steps S3, S4, S5). Steps S3, S4, and S5 do not need to be in this order. Thereafter, the flow proceeds to step S6, the setting contents of the tray is saved in the setting table concerning the p-th set, and the flow proceeds to step S7. In this way, the setting contents are saved in the setting table concerning the p-th set until it becomes that p=m.

After the finish of saving into the setting table, setting information of each set is read out from the setting table (step S9), printing data is generated based on the setting information of each set (step S10), and the printing data is transmitted to the printer 2 (step S11).

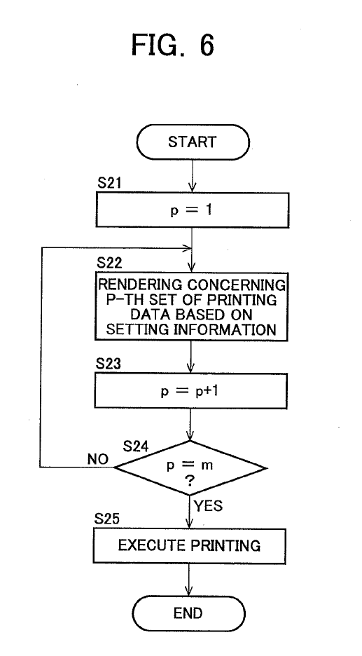

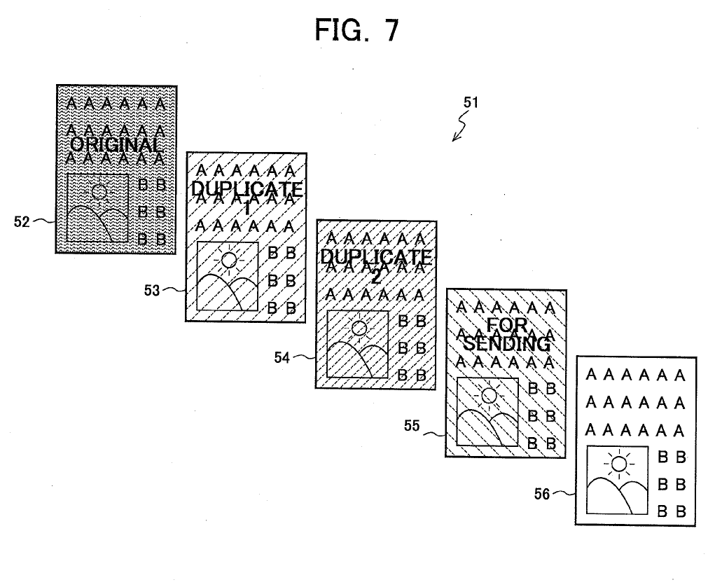

Next, description will be given for an example of printing processing in the printer 2 which received the printing data transmitted in this manner with reference to FIG. 6. FIG. 6 is a flowchart for explaining an example of processing in which printing data transmitted in the processing of FIG. 5 is printed by the printer, and FIG. 7 is a diagram showing an example of sets of printed matter in a case of executing printing with the setting contents in the UI image shown in FIG. 4.

The printer 2, after receiving and interpreting the printing data transmitted from the computer 1, sets so that p=1 (step S21). Next, rendering processing is performed concerning p-th set of printing data based on the setting information (step S22). In the rendering processing, image data that the image information to be printed is combined with the woven pattern information shown by the setting information is generated to be stored in a buffer memory.

Following step S22, p is incremented (step S23), and whether or not p=m is judged (step S24). In a case where p≠m, the flow returns to S22, and each processing of steps S22 and S23 is continued until when it becomes p=m (becoming YES at step S24). To combine the woven pattern with printing data shown by original image information, when image data subjected to the rendering processing in this way is ready for a final set (becoming YES at step S24), printing is executed (step S25).

In the example of processing procedure of FIG. 6, in the case of printing three sets of a set comprised of two pages, rendering is performed in the order of a first page of a first set, a second page of the first set, a first page of a second set, a second page of the second set, a first page of a third set, and a second page of the third set, and printing is executed.

In a case where image information to be printed is information to be one page by printing and when printed based on the setting in the UI image 40 of FIG. 4, a set of printed matter 51 as shown in FIG. 7 is output. The set of printed matter 51 is comprised of printed matter 52 of an original, printed matter 53 of the carbon 1 (duplicate 1), printed matter 54 of the carbon 2 (duplicate 2), printed matter 55 of the carbon 3 (for sending), and printed matter 56 of the carbon 4. Comparing the printed matter 56 that image information to be printed is printed without the woven pattern to the other printed matter 52 to 55, it is found out that the woven pattern set in each set is combined with the image information to be printed, and printed on each of the printed matter 52 to 55.

In addition, not limiting to the processing procedure of FIG. 6, printing may be executed for each page number of each set. For example, in the case of printing three sets of a set comprised of two pages, rendering processing is performed in the order of a first page of a first set, a first page of a second set, a first page of a third set, a second page of the first set, a second page of the second set, and a second page of the third set, and printing is executed. It may be possible for the user to select the order to be employed such that the user is able to select one that checking of printed contents is more easily performed.

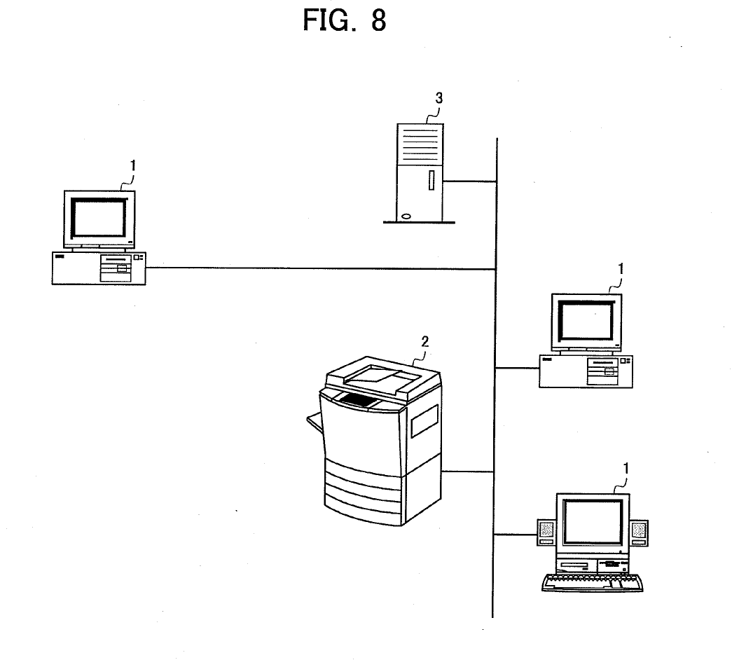

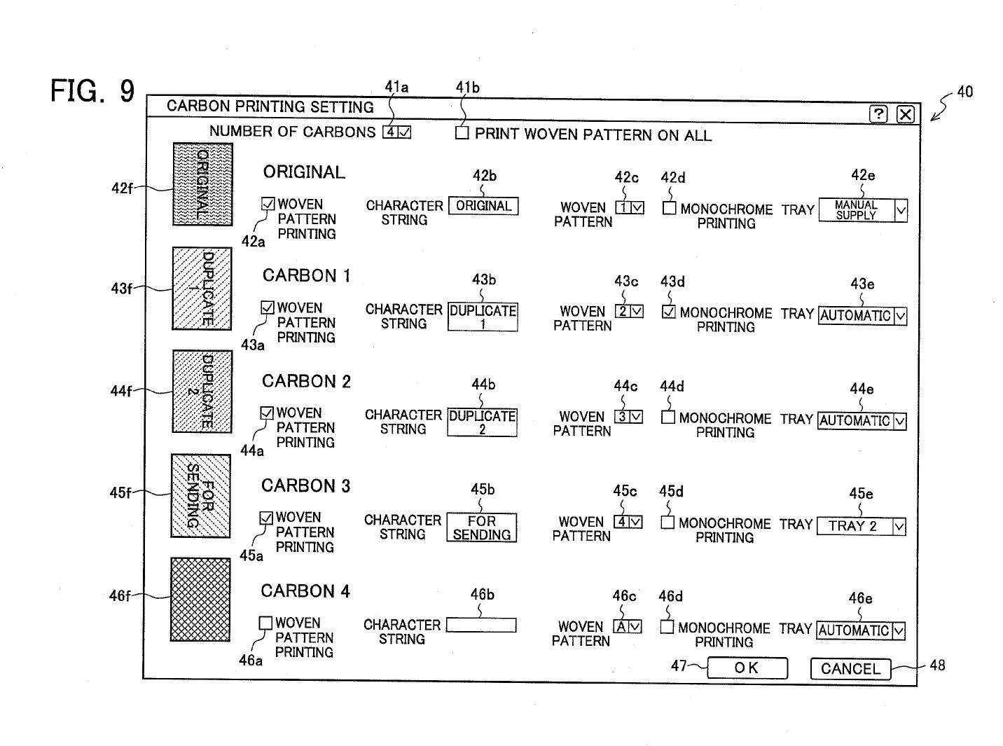

Although description has hereinbefore been given assuming that additional image information such as the woven pattern is included in the printer driver or attached to the printer driver, description will be given for other example with reference to FIG. 8 and FIG. 9. FIG. 8 is a diagram showing another exemplary configuration of the printing system including the computer in which the printer driver according to the present invention is installed, and the printer, and FIG. 9 is a diagram showing another example of the UI image for a printing setting displayed by the printer driver according to the present invention.

As illustrated in FIG. 8, in the printing system, a server that additional image information such as the woven pattern is stored (hereinafter referred to as a woven pattern management server) 3 is included in the printing system of FIG. 1. That is, the computer 1 is connected to the woven pattern management server 3 that stores the additional image information, the additional image information which is set when added may be information which is stored in a computer (server computer) other than the computer to which the printer driver is installed. The printing data generating step described above has a step of obtaining the additional image information from the woven pattern management server 3 when a setting is performed for adding the additional image information stored in the woven pattern management server 3 at the additional setting step. It is possible for the printer driver to be able to judge whether the set additional image information is stored in the woven pattern management server 3 or included in the printer driver.

The UI image displayed in such a printing system includes the UI image 40 illustrated in FIG. 9. Comparing to the UI image 40 illustrated in FIG. 4, the UI image 40 of FIG. 9 is different therefrom only in the selection setting result of the woven pattern for the carbon 4 (see the pull-down menu 46c) and the thumbnail image 46f of the woven pattern selected thereby. As illustrated here, when the user selects a woven pattern A, the printer driver determines that the woven pattern A is an external woven pattern, and downloads image data of the woven pattern A among the woven patterns registered in the woven pattern management server 3, and applies the woven pattern A to printing by combining and printing the image data. Actually, at step S4 of FIG. 5, when “A” which is a pattern to be downloaded from the woven pattern management server 3 is set as a woven pattern, downloading may be executed. Note that, as shown in FIG. 9, as a result of determination, the thumbnail image 46f is also obtained to be displayed.

In this way, the additional image information is saved in the external server so that an image desired to be standardized in a company such as a woven pattern of a slip is able to be collectively managed by a server. In addition, selection of the additional image information such as a woven pattern stored in the woven pattern management server 3 may also be performed by causing the user to designate a path to a storage area of the additional image information in the woven pattern management server 3 specifically.

In addition, in the description so far, it is assumed that printing is executed, however, instead of printing, combined image data may be generated to be saved. That is, the printer driver may include a program to cause the computer 1 to execute an image data generating step as follows.

The image data generating step is a step of generating and saving image data with the additional image information added thereto from the image information based on the setting information set at the plurality of sets setting step and the additional setting step. For example, before printing, the image data generated by rendering at step S22 of FIG. 6 is generated in a state where a plurality of different woven pattern images are combined. The image data generated in this way may be saved. Generation may be executed independently on a computer 1 side, or may be executed together with the printer 2. The saved image data is thereby able to be read out and output when necessary. In this way, the present invention is able to correspond to document filing and the like besides printing.

Note that, the image data generating step is executed instead of a printing instruction to the printer, that is, instead of the printing data generating step, and which is to be executed may be based on the user operation. Of course, even when the image data is generated in this way, it may be configured such that the additional image information is obtainable from the server, and the image data may be generated from the image information and the obtained additional image information. In addition, although description has been given such that both the generation of the printing data and the generation of the image data are executable, in the printer driver, it is also possible that a program for executing the image data generating step, instead of a program for executing the printing data generating step, is incorporated to be distributed.

As description has hereinbefore been given for processing by the printer driver 22 and the computer 1, or the printer 2, the present invention may be employed as a printing method for performing printing using the printer. In the printing method, the computer 1 connected to the printer 2, based on the user operation, performs a setting to print a plurality of sets concerning the image information to be printed and performs a setting to print with addition of different visible additional image information for each set, and generates printing data from the image information to be printed based on the set setting information. The printer 2 then receives the printing data to execute printing. Note that, to an application example of a setting method of various setting information etc., one described for the printer driver 22 and the computer 1, or the printer 2 are similarly applicable.

In addition, although the above description has been given assuming that the printing data is generated on the computer 1 side, such printing data is able to be generated by the printer 2 alone. Brief description will be given for such a printer 2. Note that, to an application example of a setting method of various setting information etc., descriptions on the printer driver 22 and the computer 1, or the printer 2 are similarly applicable. The user operation for the setting may be received by the operation portion (for example, operation portion comprised of a touch panel and a key operation portion) provided in the printer 2.

In the printer 2, it is possible to input the image information and print an image shown by the image information on the recording material. In addition, the printer 2 is provided with a plurality of sets setting portion, an additional setting portion, a printing data generating portion, and a printing portion as follows.

The plurality of sets setting portion performs a setting to print the plurality of sets concerning the inputted image information based on the user operation. The additional setting portion performs a setting to print with addition of different visible additional image information for each set based on the user operation. The additional image information may be stored in the printer 2. The printing data generating portion generates printing data from the image information based on the setting information set by the plurality of sets setting portion and the additional setting portion. The printing portion executes printing of the printing data generated by the printing data generating portion.

In addition, to such a printer, the function of the present invention is applicable not only in the case of printing from the image information, but also in the case of printing by optically reading the original document and generating the image information, that is, copying, and the above-described printing processing becomes possible.

In the printing method for executing printing by performing various setting on the printer side, the printer 2, based on the user operation, performs the setting to print the plurality of sets concerning the image information to be printed, and performs the setting to print with addition of different visible additional image information for each set, generates printing data from the image information to be printed based on the set setting information, and executes printing of the printing data.

According to the present invention, it is possible to print without causing the user to be mixed up, in outputting a plurality of sets of printed matter for the same image information, even when printing on the same types of sheets between the sets.

1. A printer driver which is incorporated in a computer to perform a printing instruction to a printer connected to the computer, wherein the printer driver includes a program to cause the computer to execute:
a plurality of sets setting step of performing a setting to print a plurality of sets concerning image information to be printed based on a user operation;
an additional setting step of performing a setting to print with addition of different visible additional image information for each set based on a user operation; and
a printing data generating step of generating printing data from the image information based on setting information set at the plurality of sets setting step and the additional setting step.

2. The printer driver as defined in claim 1, wherein a program to cause the computer to execute a tray setting step of performing a setting of a tray to supply paper in printing for each set based on a user operation is further included, and the printing data generating step generates printing data from the image information based on the setting information set at the plurality of sets setting step, the additional setting step, and the tray setting step.

3. The printer driver as defined in claim 1, wherein the additional setting step has a step of setting whether or not the additional image information is added for each set based on a user operation.

4. The printer driver as defined in claim 1, wherein the additional setting step has a step of setting a pattern to be printed as the additional image information for each set based on a user operation.

5. The printer driver as defined in claim 1, wherein the additional setting step has a step of setting a character string to be printed as a part of the additional image information for each set based on a user operation.

6. The printer driver as defined in claim 1, wherein the additional setting step has a step of performing a setting that the additional image information is printed either in color or in monochrome for each set based on a user operation.

7. The printer driver as defined in claim 1, wherein the additional image information includes information to specify the printer, the printer driver, or the computer.

8. The printer driver as defined in claim 1, wherein the computer is connected to a server which stores the additional image information, and the printing data generating step has a step of obtaining the additional image information from the server in case where a setting to add the additional image information which has been stored in the server is performed at the additional setting step.

9. The printer driver as defined in claim 1, wherein a program to cause the computer to execute an image data generating step for generating and saving image data with the additional image information added thereto from the image information based on the setting information set at the plurality of sets setting step and the additional setting step is further included.

10. A printer which prints an image show by an image information inputted thereto on recording material, comprising:
a plurality of sets setting portion to perform a setting to print a plurality of sets based on a user operation concerning the inputted image information;
an additional setting portion to perform a setting to print with addition of different visible additional image information for each set based on a user operation;
a printing data generating portion to generate printing data from the image information based on setting information set at the plurality of sets setting portion and the additional setting portion; and
a printing portion to print the printing data generated in the printing data generating portion.

11. A printing method of performing printing using a printer, including:
a plurality of sets setting step of performing a setting to print a plurality of sets concerning image information to be printed by the printer or a computer connected to the printer based on a user operation;
an additional setting step of performing a setting to print with addition of different visible additional image information for each set by the printer or the computer based on a user operation;
a printing data generating step of generating printing data from the image information by the printer or the computer based on setting information set at the plurality of sets setting step and the additional setting step; and
a step of executing printing of the printing data by the printer.
